(19) United States
(12) Patent Application Publication
(10) Pub. No.: US 2017/0220466 A1
(43) Pub. Date: Aug. 3, 2017

(54) SHARING A GUEST PHYSICAL ADDRESS SPACE AMONG VIRTUALIZED CONTEXTS

(71) Applicant: Intel Corporation, Santa Clara, CA (US)

(72) Inventors: Deepak K. Gupta, Hillsboro, OR (US); Baiju V. Patel, Portland, OR (US); Andrew V. Anderson, Forest Grove, OR (US); Gilbert Neiger, Portland, OR (US); Ravi L. Sahita, Beaverton, OR (US)

(21) Appl. No.: 15/011,501

(22) Filed: Jan. 30, 2016

(51) Int. Cl. G06F 12/08; G06F 12/10

(52) U.S. Cl. CPC G06F 12/084; G06F 12/1009; G06F 2212/152; G06F 2212/62

(57) ABSTRACT

Embodiments of an invention for sharing a guest physical address space between virtualized contexts are disclosed. In an embodiment, a processor includes a cache memory and a memory management unit. The cache memory includes a plurality of entry locations, each entry location having a guest physical address field and a host physical address field. The memory management unit includes page-walk hardware and cache memory access hardware. The page-walk hardware is to translate a guest physical address to a host physical address using a plurality of page table entries. The cache memory access hardware is to store the guest physical address and the host physical address in the cache memory only if a shareability indicator in at least one of the page table entries is set.

### BACKGROUND

1. Field

The present disclosure pertains to the field of information processing, and more particularly, to the field of virtualization in information processing systems.

2. Description of Related Art

Generally, the concept of virtualization in information processing systems allows multiple instances of one or more operating systems (each, an OS) to run on a single information processing system, even though each OS is designed to have complete, direct control over the system and its resources. Virtualization is typically implemented by using software (e.g., a virtual machine monitor (VMM) or hypervisor) to present to each OS a virtual machine (VM) having virtual resources, including one or more virtual processors, that the OS may completely and directly control, while the VMM maintains a system environment for implementing virtualization policies such as sharing and/or allocating the physical resources among the VMs (the virtual environment).

### BRIEF DESCRIPTION OF THE FIGURES

The present invention is illustrated by way of example and not limitation in the accompanying figures.

FIG. 1 illustrates an information processing system in which an embodiment of the present invention may provide for sharing a guest physical address space among virtualized contexts.

FIG. 2 illustrates a processor, including support for sharing a guest physical address space among virtualized contexts according to an embodiment of the present invention, and a system memory space accessible to the processor.

FIGS. 3 and 4 illustrate methods for sharing a guest physical address space among virtualized contexts according to an embodiment of the present invention.

### DETAILED DESCRIPTION

Embodiments of an invention for sharing a guest physical address space among virtualized contexts are described. In this description, numerous specific details, such as component and system configurations, may be set forth in order to provide a more thorough understanding of the present invention. It will be appreciated, however, by one skilled in the art, that the invention may be practiced without such specific details. Additionally, some well-known structures, circuits, and other features have not been shown in detail, to avoid unnecessarily obscuring the present invention.

In the following description, references to “one embodiment,” “an embodiment,” “example embodiment,” “various embodiments,” etc., indicate that the embodiment(s) of the invention so described may include particular features, structures, or characteristics, but more than one embodiment may and not every embodiment necessarily does include the particular features, structures, or characteristics. Further, some embodiments may have some, all, or none of the features described for other embodiments.

As used in this description and the claims and unless otherwise specified, the use of the ordinal adjectives “first,” “second,” “third,” etc. to describe an element merely indicate that a particular instance of an element or different instances of like elements are being referred to, and is not intended to imply that the elements so described must be in a particular sequence, either temporally, spatially, in ranking, or in any other manner.

Also, the terms “bit,” “flag,” “field,” “entry,” “indicator,” etc., may be used to describe any type or of or content of a storage location in a register, table, database, or other data structure, whether implemented in hardware or software, but are not meant to limit embodiments of the invention to any particular type of storage location or number of bits or other elements within any particular storage location. The term “clear” may be used to indicate storing or otherwise causing the logical value of zero to be stored in a storage location, and the term “set” may be used to indicate storing or otherwise causing the logical value of one, all ones, or some other specified value to be stored in a storage location; however, these terms are not meant to limit embodiments of the present invention to any particular logical convention, as any logical convention may be used within embodiments of the present invention.

Also, as used in descriptions of embodiments of the present invention, a “/” character between terms may mean that an embodiment may include or be implemented using, with, and/or according to the first term and/or the second term (and/or any other additional terms).

As described in the background section, information processing systems may provide support for virtualization. Various approaches to and usages of virtualization have been and continue to be developed, including those with multiple VMs, other containers (e.g., OS-managed separate and/or isolated execution environments), and/or other virtualized contexts, among which sharing of a guest physical address space according to an embodiment of the present invention may be desired to provide for efficient context switches or any other purpose. Embodiments of the present invention may be practiced using a processor having an instruction set architecture (ISA) including instructions to support virtualization, which may be part of a set of virtualization extensions to any existing ISA, or according to a variety of other approaches.

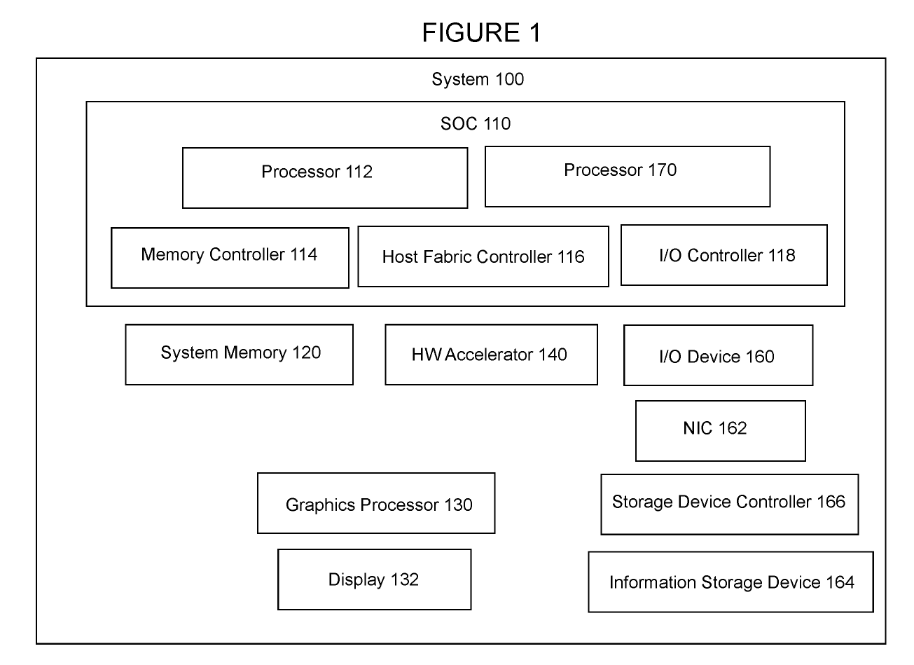

FIG. 1 illustrates system 100, an information processing system including an embodiment of the present invention for sharing a guest physical address (GPA) space between virtualized contexts. System 100 may represent any type of information processing system, such as a server, a desktop computer, a portable computer, a set-top box, a hand-held device such as a tablet or a smart phone, or an embedded control system. System 100 includes processor 112, memory controller 114, host fabric controller 116, I/O controller 118, system memory 120, graphics processor 130, and hardware accelerator 140.

Systems embodying the present invention may include any number of each of these components and any other components or other elements, such as peripherals and/or I/O devices. Any or all of the components or other elements in this or any system embodiment may be connected, coupled, or otherwise in communication with each other through any number of buses, point-to-point, or other wired or wireless interfaces or connections, unless specified otherwise. Any components or other portions of system 100, whether shown in FIG. 1 or not shown in FIG. 1, may be integrated or otherwise included on or in a single chip (a system-on-a-chip or SOC), die, substrate, or package, such as SOC 110.

System memory 120 may be dynamic random access memory (DRAM) or any other type of medium readable by processor 112. System memory 120 may be used to provide a physical memory space from which to abstract a system memory space for system 100. The content of system memory space, at various times during the operation of system 100, may include various combinations of data, instructions, code, programs, software, and/or other information stored in system memory 120 and/or moved from, moved to, copied from, copied to, and/or otherwise stored in various memories, storage devices, and/or other storage locations (e.g., processor caches and registers) in system 100.

The system memory space may be logically organized, addressable as, and/or otherwise partitioned (e.g., using any known memory management, virtualization, partitioning, and or other techniques) into regions of one or more sizes. In various embodiments, such regions may be 4K-byte pages, so, for convenience, such regions may be referred to in this description as pages; however, the use of the term “page” in this description may mean any size region of memory.

Memory controller 114 may represent any circuitry or component for accessing, maintaining, and/or otherwise controlling system memory 120. Host fabric controller 116 may represent any circuitry or component for controlling an interconnect network or fabric through which processors and/or other system components may communicate. Graphics processor 130 may include any processor or other component for processing graphics data for display 132. Hardware accelerator 140 may represent any cryptographic, compression, or other accelerator to which a processor may offload functionality such as the hardware acceleration of encryption or compression algorithms.

I/O controller 118 may represent any circuitry or component, such as a chipset component, including or through which peripheral, input/output (I/O), or other components or devices, such as I/O device 160 (e.g., a touchscreen, keyboard, microphone, speaker, other audio device, camera, video or other media device, motion or other sensor, receiver for global positioning or other information, etc.), network interface controller (NIC) 162, and/or information storage device 164, may be connected or coupled to processor 112. Information storage device 164 may represent any one or more components including any one more types of persistent or non-volatile memory or storage, such as a flash memory and/or a solid state, magnetic, or optical disk drive, and may include its own information storage device controller 166.

Processor 112 may represent all or part of a hardware component including one or more processors or processor cores integrated on a single substrate or packaged within a single package, each of which may include multiple execution threads and/or multiple execution cores, in any combination. Each processor represented as or in processor 112 may be any type of processor, including a general purpose microprocessor, such as a processor in the Intel® Core® Processor Family or other processor family from Intel® Corporation or another company, a special purpose processor or microcontroller, or any other device or component in an information processing system in which an embodiment of the present invention may be implemented. Processor 112 may be architected and designed to operate according to any ISA.

System 100 and/or SOC 110 may include one or more additional processors or processor cores (one of which is represented as processor 170), each or any of which may be any type of processor or processor core, including a processor or processor core identical to, compatible with, in the same family as, sharing any portion of the same ISA with, and/or differing in any way from processor 112.

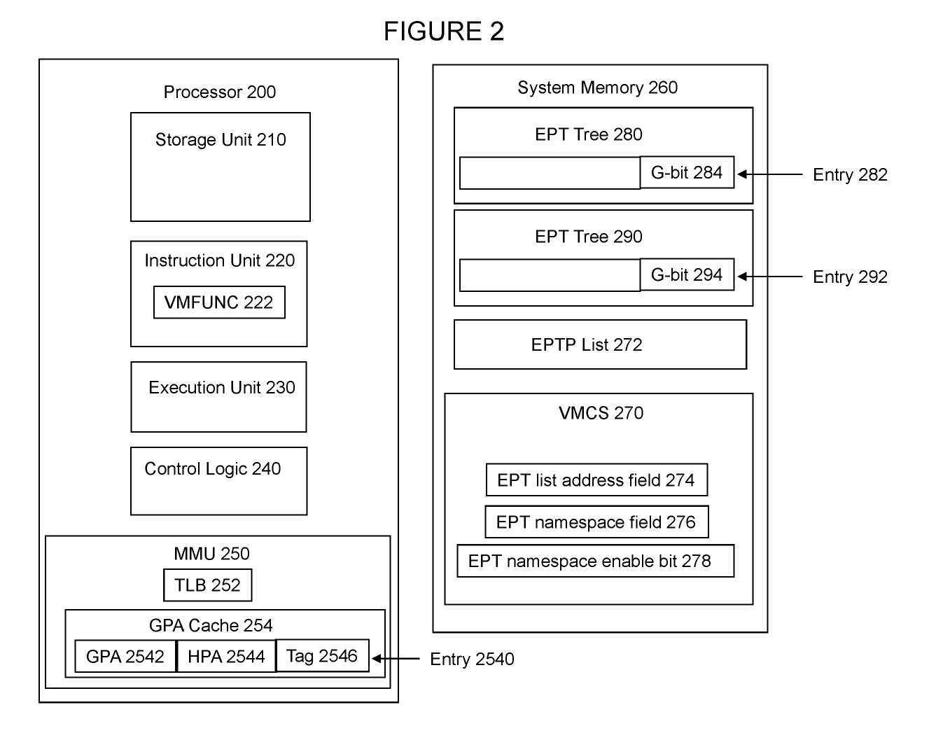

FIG. 2 illustrates processor 200 and system memory space 260 accessible to processor 200. Processor 200 may represent an embodiment of processor 112 and/or processor 170 in FIG. 1 or an execution core of a multicore processor embodiment of processor 112 and/or processor 170 in FIG. 1. Processor 200 may include storage unit 210, instruction unit 220, execution unit 230, control unit 240, and memory management unit (MMU) 250. Processor 200 may also include any other circuitry, structures, or logic not shown in FIG. 2.

Storage unit 210 may include any combination of any type of storage usable for any purpose within processor 200; for example, it may include any number of readable, writable, and/or read-writable registers, buffers, and/or caches, implemented using any memory or storage technology, in which to store capability information, configuration information, control information, status information, performance information, instructions, data, and any other information usable in the operation of processor 200, as well as circuitry usable to access such storage and/or to cause or support various operations and/or configurations associated with access to such storage.

Instruction unit 220 may include any circuitry, logic, structures, and/or other hardware, such as an instruction decoder, to fetch, receive, decode, interpret, schedule, and/or handle instructions to be executed by processor 200. Any instruction format may be used within the scope of the present invention; for example, an instruction may include an opcode and one or more operands, where the opcode may be decoded into one or more micro-instructions or micro-operations for execution by execution unit 230. Operands or other parameters may be associated with an instruction implicitly, directly, indirectly, or according to any other approach.

As further described below, processor 200 may support an instruction (VMFUNC) that allows functions provided to support virtualization to be called from within a VM, without causing a VM exit (described below). Support for this instruction may include any combination of circuitry and/or logic embedded in hardware, microcode, firmware, and/or other structures in instruction unit 220, control unit 240 (described below), and/or elsewhere in processor 200, and is represented in FIG. 2 as VMFUNC block 222.

Execution unit 230 may include any circuitry, logic, structures, and/or other hardware, such as arithmetic units, logic units, floating point units, shifters, etc., to process data and execute instructions, micro-instructions, and/or micro-operations. Execution unit 230 may represent any one or more physically or logically distinct execution units.

Control unit 240 may include any microcode, firmware, circuitry, logic, structures, and/or hardware to control the operation of the units and other elements of processor 200 and the transfer of data within, into, and out of processor 200. Control unit 240 may cause processor 200 to perform or participate in the performance of method embodiments of the present invention, such as the method embodiments described below, for example, by causing processor 200, using execution unit 230 and/or any other resources, to execute instructions received by instruction unit 220 and micro-instructions or micro-operations derived from instructions received by instruction unit 220. The execution of instructions by execution 230 may vary based on control and/or configuration information stored in storage unit 210.

MMU 250 may include any circuitry, logic, structures, and/or other hardware to manage and/or otherwise support processor 200's access to the system memory space. MMU 250 supports the use of virtual memory to provide software, including software running in a VM or other container, with an address space for storing and accessing code and data that is larger than the address space of the physical memory in the system, e.g., system memory 120. The virtual memory space of processor 200 may be limited only by the number of address bits available to software running on the processor, while the physical memory space of processor 200 may be further limited to the size of system memory 120. MMU 250 supports a memory management scheme, such as paging, to swap the executing software's code and data in and out of system memory 120 on an as-needed basis. As part of this scheme, the software may access the virtual memory space of the processor with an un-translated address that is translated by the processor to a translated address that the processor may use to access the physical memory space of the processor.

Accordingly, MMU 250 may include translation lookaside buffer 252 to store translations of a virtual, logical, linear, or other un-translated address to a physical or other translated address, according to any known memory management technique, such as paging. To perform these address translations, MMU 250 may refer to one or more data structures stored in processor 200, system memory 120, any other storage location in system 100 not shown in FIG. 1, and/or any combination of these locations. The data structures may include page directories and page tables according to the architecture of the Pentium® Processor Family.

Processor 200 may support virtualization according to any approach. For example, processor 200 may operate in two modes—a first (root) mode in which software runs directly on the hardware, outside of any virtualization environment, and a second (non-root) mode in which software runs at its intended privilege level, but within a virtual environment hosted by a VMM running in the first mode. In the virtual environment, certain events, operations, and situations, such as interrupts, exceptions, and attempts to access privileged registers or resources, may be intercepted, i.e., cause the processor to exit the virtual environment (a VM exit) so that the VMM may operate, for example, to implement virtualization policies. The processor may support instructions for establishing, entering (a VM entry), exiting, and maintaining a virtual environment, and may include register bits or other structures that indicate or control virtualization capabilities of the processor.

In describing embodiments of the present invention, any platform, system, or machine, including the “bare metal” platform shown as system 100 in FIG. 1 (as well as any VM or other container abstracted from a bare metal platform, from which one or more VMs or other containers may be abstracted) may be referred to as a host or host machine, and each VM abstracted from a host machine may be referred to as a guest or guest machine. Accordingly, the term “host software” may mean any hypervisor, VMM, OS, or any other software that may run, execute, or otherwise operate on a host machine and create, maintain, and/or otherwise manage one or more VMs, and the term “guest software” may mean any OS, system, application, user, or other software that may run, execute, or otherwise operate on a guest machine. Note that in a layered container architecture, software may be both host software and guest software. For example, a first VMM running on a bare metal platform may create a first VM, in which a second VMM may run and create a second VM abstracted from the first VM, in which the case the second VMM is both host software and guest software.

Processor 200 may control the operation of one or more VMs according to data stored in one or more virtual machine control structures (each, a VMCS). A VMCS (e.g., VMCS 270) is a data structure that may contain state of one or more guests, state of a host, execution control information indicating how a VMM is to control operation of a guest or guests, execution control information indicating how VM exits and VM entries are to operate, information regarding VM exits and VM entries, and any other such information. Processor 200 may read information from a VMCS to determine the execution environment of a VM and constrain its behavior. Embodiments may use one VMCS per VM or any other arrangement. Each VMCS may be stored, in whole or in part, in system memory 120, and/or elsewhere, such as being copied to a cache memory of a processor.

Each VMCS may include any number of indicators or other controls to protect any number of different processor and/or system resources. For example, any size area of memory may be protected at any granularity (e.g., a 4 KB page) using a set of extended page tables (EPT), which provide for each VM, if desired, to have its own virtual memory space and, from the perspective of a guest OS, its own physical memory space. The addresses that a guest application uses to access its linear or virtual memory may be translated, using page tables configured by a guest OS, to addresses in the memory space that appears (through the virtualization supported by the processor and the VMM) as system memory to the guest OS (each, a guest physical address or GPA). The GPAs may be translated to addresses (each, a host physical address or HPA) in actual system memory (e.g., system memory 120), through the EPTs (which may have been configured by the VMM prior to a VM entry) without causing a VM exit. EPTs may be nested or otherwise associated with other page table hierarchies (e.g., those used to translate virtual addresses to physical addresses when in root mode) to provide multiple levels of translation. Furthermore, EPT entries may include permissions (e.g., read, write, and/or execute permissions) and/or other indicators to enforce access restrictions instead of or in addition to access attributes included in page tables with which the EPTs may be nested.

Therefore, EPTs may be used to create protected domains in system memory. Each such domain may correspond to a different set of EPT paging structures, each defining a different view of memory with different access permissions (each, a permission view), and each referenced by a different EPT pointer (EPTP). A switch from one permission view to another permission view (for example, as a result of loading a different EPTP value into a designated VM-execution control field in a VMCS) may be called a view switch.

From within a VM, an attempt to perform an unpermitted access to a page or other data structure in a protected domain is called an EPT violation and may cause a VM exit, which may provide for a VMM, hypervisor, or other host software (each of which may be referred to as a VMM for convenience) to determine whether the access should be permitted. If so, the VMM may perform a view switch and cause a re-entry into the VM. To avoid the overhead of the VM exit involved in this scenario, an instruction (VMFUNC) may be used to allow a view switch to be performed from non-root mode (i.e., from within a VM), without causing a VM exit. A first parameter associated with the VMFUNC instruction (e.g., the value in the EAX register in a processor in the Intel® Core® Processor Family) may specify that the function to be invoked is an EPT pointer (EPTP) switching function (for example, the value of ‘0’ in the EAX register may specify the EPTP switching function, which may therefore be referred to as VMFUNC(0)). To provide for a VMM to enforce domain protections, software running in non-root mode may be limited to selecting from a list of EPTP values configured in advance by root-mode software. Then, a second parameter associated with the VMFUNC instruction (e.g., the value in the ECX register in a processor in the Intel® Core® Processor Family) may be used as an index to select an entry from the EPTP list. If the specified entry is invalid or does not exist, the VMFUNC(0) instruction may result in a VM exit.

Note that the name of the VMFUNC instruction is provided merely for convenience, and embodiments of the present invention may include such an instruction having any name desired. In various embodiments, one or more variants of this instruction may be added to an existing ISA as an enhancement, extension, leaf, or other variant of one or more new or existing instructions or opcodes.

The virtualization functionality and support described above may be subject to any number and/or level of enablement controls. In an embodiment, a global virtualization control, e.g. a first designated bit in a control register in storage unit 210, may be used to enable or disable the use of non-root mode. A secondary controls activation control, e.g., a second designated bit in a designated VM-execution control field of a VMCS, may be used to enable a secondary level of controls for execution in non-root mode. The secondary controls may include an EPT enable control, e.g., a third designated bit in a designated VM-execution control field of the VMCS, which may be used to enable the use of EPTs. The secondary controls may also include a VM function enable control, e.g., a fourth designated bit in a designated VM-execution control field of the VMCS, which may be used to enable the use of the VMFUNC instruction. A VMFUNC(0) control bit, e.g., a fifth designated bit in a designated VM-function control field of a VMCS, may be used to enable the use of the EPTP switching function. Note that in this embodiment, the use of EPTs and the EPTP switching function is not enabled unless all of five control bits described above are set. A VMCS may include other and/or additional control bits as may be described below.

A VMM may create multiple sets or trees of EPTs (e.g., EPT trees 280 and 290) for use within a single VM, and may create a populated EPTP list (e.g., EPTP list 272) including multiple pointers, where each pointer is to one of the multiple sets of EPTs). The VMFUNC(0) instruction may reference a designated VM-function field of a VMCS (e.g., field 274 of VMCS 270) for the address of the EPTP list. Therefore, the VMM may load the address of populated EPTP list 272 into EPTP list address field 274 in order for a VM controlled by VMCS 270 to use the VMFUNC(0) instruction without resulting in a VM exit.

Therefore, the memory management and virtualization features of a processor may be used to create various contexts, including VMs, containers, execution environments, etc., which may use the same system memory space, but with one or more levels of address translation between an address used by software and an address used to access a physical memory. One such level of translation may be from a GPA to an HPA. Embodiments of the present invention may be used if it is desired to efficiently share one or more GPA to HPA translations, and therefore part or all of a GPA space, between or among multiple contexts.

In various embodiments, various approaches to switching between contexts may be possible. According to a first approach, a VMFUNC(0) instruction may be used by guest software, running in non-root mode on a VM, to switch from a first EPTP (associated with or corresponding to a first context) to a second EPTP (associated with or corresponding to a second context), without a VM exit. According to a second approach, a VM exit from a first VM controlled by a first VMCS using a first tree of EPTs may occur, followed by a VM entry to a second VM controlled by a second VMCS using a second tree of EPTs. Other approaches are possible.

To provide for sharing of GPA to HPA translations according one or more of these approaches, processor 200 and/or system memory space 250 may include a storage structure in which GPA to HPA translations may be stored, such that a GPA to HPA translation stored in the storage structure may be used by more than one context. For example, a GPA to HPA translation may be stored in the storage structure and used by a first context while a first EPT tree is active (e.g., a first EPTP is in use), be retained or otherwise persist across an EPT switch to a second EPT tree, and be read from the storage structure to be used by a second context (different from the first context) while the second EPT tree (different from the first EPT tree) is active (e.g., a second EPTP, different from the first EPTP, is in use). In an embodiment, the storage structure may be a cache memory within processor 200, represented by GPA cache 254 in FIG. 2. In another embodiment, the storage structure may be a data structure within system memory space 260, and other embodiments are also possible. Therefore, any description in this specification that refers to GPA cache 254 may alternatively be implemented according to any of these other embodiments.

GPA cache 254 may include any number of entry locations (e.g., one of which is shown as GPA cache entry 2540), each to store a GPA (e.g., in field 2542), a corresponding HPA (e.g., in field 2544) to which the GPA is to be translated according to one or more EPTs or other approaches to address translation, and in some embodiments and as further described below, an EPT namespace tag (e.g., in field 2546). To provide for storing entries in the entry locations of GPA cache 254, the format of an EPT entry (e.g., EPT entries 282 and 292) may include a storage location (e.g., G-bits 284 and 294) to store an indicator to specify whether the GPA to HPA translation resulting from the use of the entry is to be shared between contexts. If the G-bit is set, the resulting GPA to HPA translation may be used to access physical memory and stored in GPA cache 254. If the G-bit is not set, the resulting GPA to HPA translation may be used to access physical memory without storing it in GPA cache 254. G-bits may be set and cleared by a VMM and/or other system software to manage the shareability of GPA to HPA translations between and among contexts. An EPT entry having a set G-bit and any GPA to HPA translation resulting from the use of the EPT entry while its G-bit is set may be referred to as global and/or shareable.

In various embodiments, global GPA to HPA translations may be shared between or among contexts, but only by contexts within the same EPT namespace (e.g., set of EPT trees), where multiple EPT namespaces may be defined to allow sharing of different groups of GPA to HPA translations. For example, a first set of GPA to HPA translations may be shared by a first set of contexts within a first EPT namespace and a second set of GPA to HPA translations may be shared by a second set of contexts within a second EPT namespace. In some embodiments, an EPT namespace tag (e.g., in field 2546) may be used to identify the EPT namespace to which each GPA cache entry belongs.

Various approaches to defining and tagging EPT namespaces are possible. In an embodiment, an EPT list (e.g., EPT list 272) may be used to define an EPT namespace. For example, any GPA to HPA translation resulting from the use of any shareable EPT entry in any EPT tree pointed to by any EPTP pointers in an EPT list may be stored in the GPA cache to be used by any context using the same EPT list, where an identifier of the EPT list (e.g., its address) may be used as the EPT namespace tag. In another embodiment, a VMCS may be used to define an EPT namespace. For example, a field in a VMCS (e.g., EPT namespace field 276) may be used to store an EPT namespace tag, such that GPA to HPA translations may be shared across EPT trees used by VMCSs having the same EPT namespace tag. The use of an EPT namespace tag from a VMCS may be enabled and disabled using a secondary control bit (e.g., bit 278) in the VMCS.

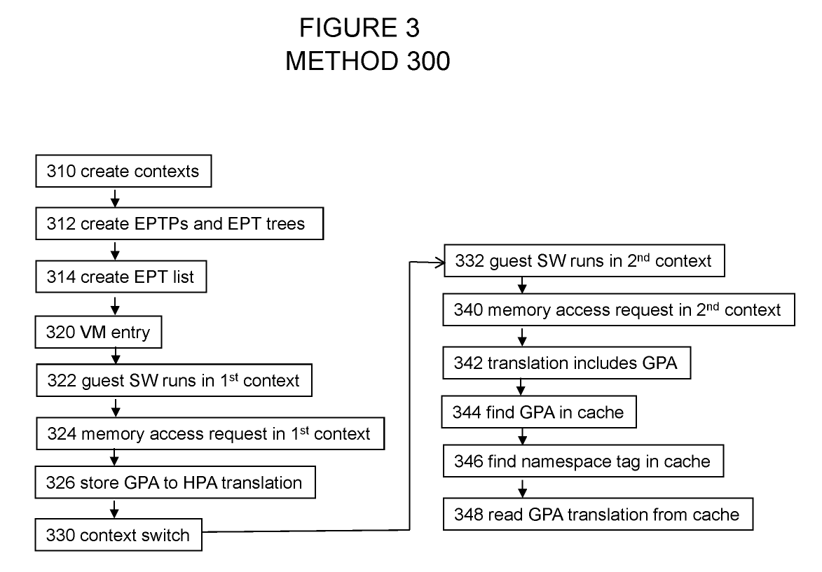

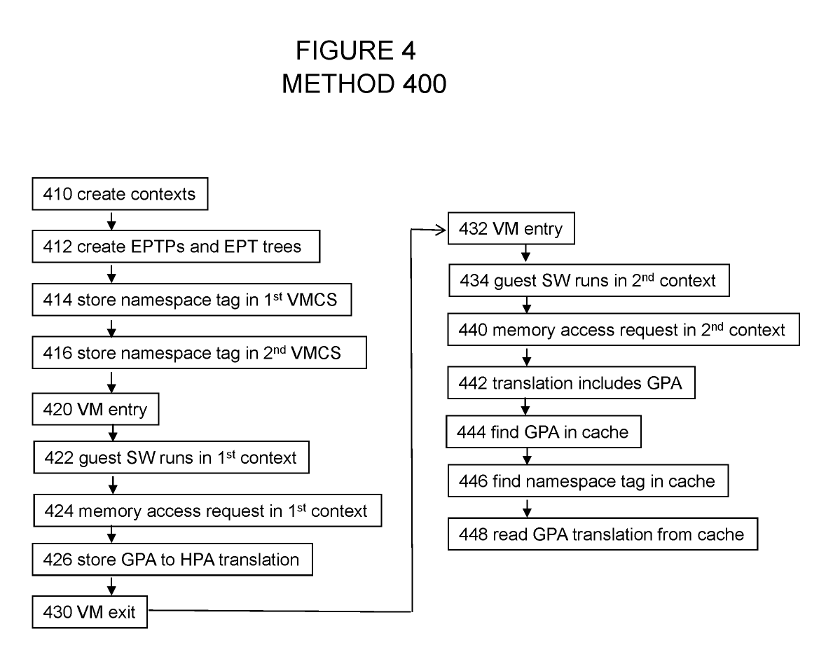

FIGS. 3 and 4 illustrate methods 300 and 400, respectively, for sharing a guest physical address space among virtualized contexts according to an embodiment of the present invention. Although method embodiments of the invention are not limited in this respect, reference may be made to elements of FIGS. 1 and 2 to help describe the method embodiments of FIGS. 3 and 4. Various portions of methods 300 and 400 may be performed by hardware, firmware, software, and/or a user of a system such as system 100.

In box 310 of method 300, a VMM, OS, or other system software may create and/or prepare one or more contexts (including a first context and a second context) on an information processing system (e.g., system 100). Box 310 may include, for each VM associated with a context, creating and/or storing a VMCS (e.g., VMCS 270).

In box 312, an EPTP and an associated EPT tree (e.g., EPT tree 280, 290) is created and/or stored for each context. Box 312 may include setting a G-bit (e.g., G-bit 284, 294) in each EPT entry (e.g., EPT entry 282, 292) that is desired to be associated with a shareable GPA to HPA translation.

In box 314, an EPTP list (e.g., EPTP list 272) is created and/or stored for each EPT namespace. Box 314 may include storing each EPTP in an associated VMCS.

In box 320, a VM entry occurs to allow guest software to run in a VM having an associated VMCS including an EPTP list, the EPTP list including a first EPTP corresponding to a first EPT tree and a second EPTP (different from the first) corresponding to a second EPT tree (different from the first). In box 322, the guest software runs in a first context for which the first EPTP and first EPT tree are enabled and/or active. In box 324, a memory access (e.g., to system memory 120), including an address translation (e.g., including a page-walk through Intel® Architecture and EPT paging structures) in the first context is performed (e.g., by page-walk hardware 256 in MMU 250), the address translation including performing a translation from a first GPA to a first HPA based on a global EPT entry in the first EPT tree. In box 326, the GPA to HPA translation from box 324 is stored (e.g., by GPA cache access hardware 258 in MMU 250) in an entry (e.g., entry 2540) in a GPA cache (e.g., GPA cache 254). In an embodiment, box 326 may include storing the first GPA (e.g., in field 2542), the first HPA (e.g., in field 2544), and an EPT namespace tag (e.g., in field 2546) in the GPA cache entry.

In box 330, a context switch is performed (e.g., using a VMFUNC instruction) without a VM exit. Box 330 may include switching from the first EPTP and the first EPT tree to the second EPTP and the second EPT tree. In box 332, the guest software runs in a second context for which the second EPTP and second EPT tree are enabled and/or active.

In box 340, a memory access, including an address translation in the second context, is initiated. In box 342, it is determined (e.g., by MMU 250) that the address translation is to include a translation of the first GPA. In box 344, it is determined (e.g., by MMU 250) that an entry (e.g., the entry stored in box 326) for the first GPA exists in the GPA cache. In box 346, it is determined that the tag in the entry corresponds to the second context. Therefore, in box 348, the HPA from the entry (e.g., the first HPA) is read from the GPA cache (e.g., instead of performing a page-walk to translate the GPA to the HPA) and used to perform the memory access.

In box 410 of method 400, a VMM, OS, or other system software may create and/or prepare one or more contexts (including a first context and a second context) on an information processing system (e.g., system 100). Box 410 may include, for each VM associated with a context, creating and/or storing a VMCS (e.g., VMCS 270).

In box 412, an EPTP and an associated EPT tree (e.g., EPT tree 280, 290) is created and/or stored for each context, including a first EPTP and a first EPT tree for a first VMCS and a second EPTP (different from the first) and a second EPT tree (different from the first) for a second VMCS. Box 412 may include setting a G-bit (e.g., G-bit 284, 294) in each EPT entry (e.g., EPT entry 282, 292) that is desired to be associated with a shareable GPA to HPA translation.

In box 414, an EPT namespace tag is stored in an EPT namespace field (e.g., field 276) of the first VMCS, and EPT namespace tagging is enabled for the first VMCS (e.g., by setting bit 278). In box 416, the same EPT namespace tag is stored on an EPT namespace field of the second VMCS, and EPT namespace tagging is enabled for the second VMCS.

In box 420, a VM entry occurs to allow guest software to run in the first VM having associated with it the first VMCS. In box 422, the guest software runs in the first VM, in a first context corresponding to the first EPTP and first EPT tree. In box 424, a memory access (e.g., to system memory 120), including an address translation (e.g., including a page-walk through Intel® Architecture and EPT paging structures) in the first context is performed (e.g., by page-walk hardware 256 in MMU 250), the address translation including performing a translation from a first GPA to a first HPA based on a global EPT entry in the first EPT tree. In box 426, the GPA to HPA translation from box 424 is stored (e.g., by GPA cache access hardware 258 in MMU 250) in an entry (e.g., entry 2540) in a GPA cache (e.g., GPA cache 254). In an embodiment, box 426 may include storing the first GPA (e.g., in field 2542), the first HPA (e.g., in field 2544), and an EPT namespace tag (e.g., in field 2546) in the GPA cache entry.

In box 430, a VM exit from the first VM occurs, for example in response to an attempted context switch. The VM exit includes a transfer of control from the guest software to host software. In box 432, a VM entry into the second VM occurs (e.g., by the host software invoking a VM entry instruction such as VMENTER or VMRESUME), and effect of which is a context switch from the first context to a second context corresponding to the second EPTP and second EPT tree. In box 434, guest software runs in the second VM, in the second context.

In box 440, a memory access, including an address translation in the second context, is initiated. In box 442, it is determined (e.g., by MMU 250) that the address translation is to include a translation of the first GPA. In box 444, it is determined (e.g., by MMU 250) that an entry (e.g., the entry stored in box 426) for the first GPA exists in the GPA cache. In box 446, it is determined that the tag in the entry corresponds to the second context. Therefore, in box 448, the HPA from the entry (e.g., the first HPA) is read from the GPA cache (e.g., instead of performing a page-walk to translate the GPA to the HPA) and used to perform the memory access.

In various embodiments, the methods illustrated in FIGS. 5 and 6 may be performed in a different order, with illustrated boxes combined or omitted, with additional boxes added, or with a combination of reordered, combined, omitted, or additional boxes. Furthermore, method embodiments are not limited to method 500, method 600, or variations thereof. Many other method embodiments (as well as apparatus, system, and other embodiments) not described herein are possible within the scope of the present invention.

According to a first example of another embodiment, a GPA cache may also be used to store partial translations of a GPA to an HPA. In such an embodiment, the G-bit in one or more EPT entries may be used to indicate whether a corresponding portion of a translation is to be stored in the GPA cache.

According to a second example of another embodiment, a leaf or other variation of a VMFUNC instruction may be used to perform a view switch (e.g., change the EPTP and also change the namespace tag (e.g., the content of field 2546).

Embodiments or portions of embodiments of the present invention, as described above, may be stored on any form of a machine-readable medium. For example, all or part of method 500 or 600 may be embodied in software or firmware instructions that are stored on a medium readable by a processor, which when executed by a processor, cause the processor to execute an embodiment of the present invention. Also, aspects of the present invention may be embodied in data stored on a machine-readable medium, where the data represents a design or other information usable to fabricate all or part of a processor or other component.

Thus, embodiments of an invention for sharing a guest physical address space between virtualized contexts have been described. While certain embodiments have been described, and shown in the accompanying drawings, it is to be understood that such embodiments are merely illustrative and not restrictive of the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A processor comprising:
a cache memory including a plurality of entry locations, each entry location having a guest physical address field and a host physical address field; and
a memory management unit including
page-walk hardware to translate a guest physical address to a host physical address using a plurality of page table entries; and
cache memory access hardware to store the guest physical address and the host physical address in the cache memory only if a shareability indicator in at least one of the page table entries is set.

2. The processor of claim 1, wherein the memory management unit is to perform a translation of the guest physical address to the host physical address using the cache memory instead of the page-walk hardware if the cache memory includes an entry corresponding to the guest physical address.

3. The processor of claim 2, wherein each entry location also has a namespace tag field in which to store a namespace tag.

4. The processor of claim 3, wherein the memory management unit is to perform the translation using the cache memory instead of the page-walk hardware only if the namespace tag in the entry corresponding to the guest physical address corresponds to a context in which the translation is to be performed.

5. The processor of claim 2, wherein:
the memory management unit is to store the guest physical address and the host physical address in the cache memory during execution of guest software in a first context, and
the memory management unit is to perform the translation of the guest physical address to the host physical address using the cache memory instead of the page-walk hardware if the cache memory includes an entry corresponding to the guest physical address during execution of guest software in a second context.

6. The processor of claim 5, further comprising an instruction unit to receive an instruction to perform a context switch from the first context to the second context within a virtual machine without causing a virtual machine exit, wherein the entry corresponding to the guest physical address is to be retained in the cache memory during the context switch if the shareability indicator in at least one of the page table entries of the first context was set.

7. The processor of claim 5, wherein a context switch from the first context to the second context includes a virtual machine exit from a first virtual machine configured to execute guest software in the first context followed by a virtual machine entry to a second virtual machine configured to execute guest software in the second context, wherein the entry corresponding to the guest physical address is to be retained in the cache memory during the context switch if the shareability indicator in at least one of the page table entries of the first context was set.

8. A method comprising:
translating a guest physical address to a host physical address using a plurality of page table entries; and
storing the guest physical address and the host physical address in a cache memory only if a shareability indicator in at least one of the page table entries is set.

9. The method of claim 8, further comprising translating the guest physical address to the host physical address using the cache memory instead of the page-walk hardware if the cache memory includes an entry corresponding to the guest physical address.

10. The method of claim 9, wherein storing the guest physical address and the host physical address in the cache memory also includes storing a corresponding namespace tag.

11. The method of claim 10, wherein translating the guest physical address to the post physical address is performed using the cache memory instead of the page-walk hardware only if the namespace tag in the entry corresponding to the guest physical address corresponds to a context in which the translation is to be performed.

12. The method of claim 9, wherein:
storing the guest physical address and the host physical address in the cache memory is performed during execution of guest software in a first context, and
translating the guest physical address to the host physical address using the cache memory instead of the page-walk hardware if the cache memory includes an entry corresponding to the guest physical address is performed during execution of guest software in a second context.

13. The method of claim 12, further comprising executing an instruction to perform a context switch from the first context to the second context within a virtual machine without causing a virtual machine exit, wherein the entry corresponding to the guest physical address is to be retained in the cache memory during the context switch if the shareability indicator in at least one of the page table entries of the first context was set.

14. The method of claim 12, wherein a context switch from the first context to the second context includes a virtual machine exit from a first virtual machine configured to execute guest software in the first context followed by a virtual machine entry to a second virtual machine configured to execute guest software in the second context, wherein the entry corresponding to the guest physical address is to be retained in the cache memory during the context switch if the shareability indicator in at least one of the page table entries of the first context was set.

15. A system comprising:
a system memory in which to store a first plurality of page table entries; and
a processor including:
a cache memory including a plurality of entry locations, each entry location having a guest physical address field and a host physical address field; and
a memory management unit including
page-walk hardware to translate a guest physical address to a host physical address using the first plurality of page table entries; and
cache memory access hardware to store the guest physical address and the host physical address in the cache memory only if a shareability indicator in at least one of the first plurality of page table entries is set.

16. The system of claim 15, wherein the memory management unit is to perform a translation of the guest physical address to the host physical address using the cache memory instead of the page-walk hardware if the cache memory includes an entry corresponding to the guest physical address.

17. The system of claim 16, wherein:
the memory management unit is to store the guest physical address and the host physical address in the cache memory during execution of guest software in a first context, and
the memory management unit is to perform the translation of the guest physical address to the host physical address using the cache memory instead of the page-walk hardware if the cache memory includes an entry corresponding to the guest physical address during execution of guest software in a second context.

18. The system of claim 17, further comprising an instruction unit to receive an instruction to perform a context switch from the first context to the second context within a virtual machine without causing a virtual machine exit, wherein the entry corresponding to the guest physical address is to be retained in the cache memory during the context switch if the shareability indicator in at least one of the page table entries of the first context was set.

19. The system of claim 17, wherein a context switch from the first context to the second context includes a virtual machine exit from a first virtual machine configured to execute guest software in the first context followed by a virtual machine entry to a second virtual machine configured to execute guest software in the second context, wherein the entry corresponding to the guest physical address is to be retained in the cache memory during the context switch if the shareability indicator in at least one of the page table entries of the first context was set.

20. The system of claim 15, wherein:
the first plurality of page table entries is within an extended page table tree to be used to translate guest physical addresses to host physical addresses; and
the system memory is also to include a second plurality of page table entries to be used to translate guest virtual addresses to guest virtual addresses.
